(19) United States
(12) Patent Application Publication
(10) Pub. No.: US 2022/0090670 A1
(43) Pub. Date: Mar. 24, 2022

(54) SINGLE DRIVE POSITIONING SYSTEMS AND METHODS AND MASS ANALYSIS SYSTEMS INCLUDING SAME

(71) Applicant: PerkinElmer Health Sciences Canada, Inc., Woodbridge (CA)

(72) Inventor: Matthew Hassenbach, Hillsburgh (CA)

(21) Appl. No.: 17/462,239

(22) Filed: Aug. 31, 2021

Related U.S. Application Data
(60) Provisional application No. 63/081,976, filed on Sep. 23, 2020.

(51) Int. Cl. F16H 55/22; H01J 49/10; F16H 37/06

(52) U.S. Cl. CPC F16H 55/22; F16H 2712/06; F16H 37/065; H01J 49/105

(57) ABSTRACT

A single drive positioning system includes a drive shaft, a motor, a first worm screw, and a second worm screw. The motor has a motor output connected to the drive shaft and operable to selectively rotate the drive shaft. The first worm screw is mounted on the drive shaft for rotation therewith. The second worm screw is mounted on the drive shaft for rotation therewith.

### RELATED APPLICATION(S)

The present application claims the benefit of and priority from U.S. Provisional Patent Application No. 63/081,976, filed Sep. 23, 2020, the disclosure of which is incorporated herein by reference in its entirety.

### FIELD

The present technology relates to motor-driven positioning systems and, more particularly, to motor-driven multi-axis positioning systems.

### BACKGROUND

Conventional dual axis positioning systems typically require two motors and/or other powered actuators (e.g., gear changers) to drive both axes. Positioning systems are used for various purposes. For example, some inductively coupled plasma (ICP) mass spectroscopy (MS) devices use a positioning stage to align a torch to an MS interface.

### SUMMARY

In one aspect, a single drive positioning system includes a drive shaft, a motor, a first worm screw, and a second worm screw. The motor has a motor output connected to the drive shaft and operable to selectively rotate the drive shaft. The first worm screw is mounted on the drive shaft for rotation therewith. The second worm screw is mounted on the drive shaft for rotation therewith.

In some embodiments the single drive positioning system includes a first overrunning clutch between the first worm screw and the motor output, and a second overrunning clutch between the second worm screw and the motor output.

In some embodiments, the motor is operable to rotate the drive shaft in each of a clockwise direction and a counterclockwise direction. The first overrunning clutch is configured to drive the first worm screw in the clockwise direction when the drive shaft is driven in the clockwise direction, and to permit the drive shaft to rotate independently of the first worm screw when the drive shaft is driven in the counterclockwise direction. The second overrunning clutch is configured to drive the second worm screw in the counterclockwise direction when the drive shaft is driven in the counterclockwise direction, and to permit the drive shaft to rotate independently of the second worm screw when the drive shaft is driven in the clockwise direction.

According to some embodiments, the first overrunning clutch includes a first one-way bearing coupling the first worm screw to the drive shaft, and the second overrunning clutch includes a second one-way bearing coupling the second worm screw to the drive shaft.

In some embodiments, the first one-way bearing is radially interposed between the first worm screw and the drive shaft, and the second one-way bearing is radially interposed between the second worm screw and the drive shaft.

According to some embodiments, the first and second one-way bearings are one-way needle bearings.

In some embodiments, the single drive positioning system includes: a first worm drive including the first worm screw and a first worm wheel intermeshed with the first worm screw; and a second worm drive including the second worm screw and a second worm wheel intermeshed with the second worm screw.

According to some embodiments, the first worm drive and the second worm drive are self-locking worm drives such that the first and second worm screws are not backwards drivable by the first and second worm wheels.

In some embodiments, the first and second worm screws are mounted on the drive shaft at axially fixed locations along the drive shaft.

According to some embodiments, the single drive positioning system includes: a first rotary-to-linear motion mechanism configured to be driven by rotation of the first worm wheel; and a second rotary-to-linear motion mechanism configured to be driven by rotation of the second worm wheel.

In some embodiments, at least one of the first and second rotary-to-linear motion mechanisms includes a slider-crank mechanism including a crank and a reciprocating connecting member.

In some embodiments, at least one of the first and second rotary-to-linear motion mechanisms includes a cam mechanism including a cam and a cam follower.

According to some embodiments, the single drive positioning system includes a slide bearing system including: a frame; a first guide member slidably mounted on the frame for movement along a first displacement axis; and a second guide member slidably mounted on the frame for movement along a second displacement axis extending transverse to the first displacement axis. The first rotary-to-linear motion mechanism is configured to displace the first guide member along the first displacement axis when the first worm screw is driven in the clockwise direction. The second rotary-to-linear motion mechanism is configured to displace the second guide member along the second displacement axis when the second worm screw is driven in the counterclockwise direction.

In some embodiments, the single drive positioning system includes a flexure bearing system including: a frame; a carrier; and at least one bendable flexure member connecting the carrier to the frame such that the carrier is movable along each of a first displacement axis and a second displacement axis extending transverse to the first displacement axis. The first rotary-to-linear motion mechanism is configured to displace the carrier along the first displacement axis when the first worm screw is driven in the clockwise direction. The second rotary-to-linear motion mechanism is configured to displace the carrier along the second displacement axis when the second worm screw is driven in the counterclockwise direction.

According to some embodiments, the single drive positioning system is configured for use with an object, and is configured to: displace the object along or about a first displacement axis when the first worm screw is driven in the clockwise direction; and displace the object along or about a second displacement axis when the second worm screw is driven in the counterclockwise direction.

In some embodiments, the first displacement axis is a linear axis, and the second displacement axis is a linear axis extending transverse to the first displacement axis.

According to some embodiments, the motor is operable to rotate the drive shaft about a drive shaft axis, and the drive shaft axis extends at an oblique angle to the first displacement axis and at an oblique angle to the second displacement axis.

In a second aspect, a method for positioning an object includes providing a single drive positioning system including: a drive shaft; a motor having a motor output connected to the drive shaft and operable to selectively rotate the drive shaft; a first worm screw mounted on the drive shaft for rotation therewith; and a second worm screw mounted on the drive shaft for rotation therewith. The method further includes operating the motor to rotate the drive shaft.

In a third aspect, a single drive positioning system includes a drive shaft, a motor, a first worm drive, second worm drive, a first overrunning clutch, and a second overrunning clutch. The motor has a motor output connected to the drive shaft and operable to selectively rotate the drive shaft in each of a clockwise direction and a counterclockwise direction. The first worm drive includes: a first worm screw mounted on the drive shaft for rotation therewith; and a first worm wheel intermeshed with the first worm screw. The second worm drive includes: a second worm screw mounted on the drive shaft for rotation therewith; and a second worm wheel intermeshed with the second worm screw. The first overrunning clutch is located between the drive shaft and the first worm screw. The first overrunning clutch is configured to drive the first worm screw in the clockwise direction when the drive shaft is driven in the clockwise direction, and to permit the drive shaft to rotate independently of the first worm screw when the drive shaft is driven in the counterclockwise direction. The second overrunning clutch is located between the drive shaft and the first worm screw. The second overrunning clutch is configured to drive the second worm screw in the counterclockwise direction when the drive shaft is driven in the counterclockwise direction, and to permit the drive shaft to rotate independently of the second worm screw when the drive shaft is driven in the clockwise direction.

In a fourth aspect, a mass analysis system includes an ICP torch, a sample introduction element including an inlet, and a single drive positioning system. The single drive positioning system is operable to selectively align the ICP torch with the inlet. The single drive positioning system includes: a drive shaft; a motor having a motor output connected to the drive shaft and operable to selectively rotate the drive shaft; a first worm screw mounted on the drive shaft for rotation therewith; and a second worm screw mounted on the drive shaft for rotation therewith.

In some embodiments, the motor is operable to the rotate the drive shaft in each of a clockwise direction and a counterclockwise direction, and the single drive positioning system is configured to: adjust a position of the ICP torch along or about a first displacement axis by rotating the drive shaft in the clockwise direction; and adjust a position of the ICP torch along or about a second displacement axis by rotating the drive shaft in the counterclockwise direction.

According to some embodiments, the mass analysis system includes a mass analyzer located downstream of the inlet from the ICP torch.

In a fifth aspect, a method for conducting a mass analysis of a sample includes providing a mass analysis system including: an ICP torch; a sample introduction element including an inlet; and a single drive positioning system. The single drive positioning system is operable to selectively align the ICP torch with the inlet. The single drive positioning system includes: a drive shaft; a motor having a motor output connected to the drive shaft and operable to selectively rotate the drive shaft; a first worm screw mounted on the drive shaft for rotation therewith; and a second worm screw mounted on the drive shaft for rotation therewith. The method further includes operating the motor to rotate the drive shaft.

### BRIEF DESCRIPTION OF THE DRAWINGS

The accompanying drawings, which form a part of the specification, illustrate embodiments of the technology.

FIG. 1 is a top perspective view of a single drive positioning system according to some embodiments.

FIG. 2 is a bottom perspective view of the single drive positioning system of FIG. 1.

FIG. 3 is an exploded, top view of the single drive positioning system of FIG. 1.

FIG. 4 is top view of the single drive positioning system of FIG. 1.

FIG. 5 is bottom view of the single drive positioning system of FIG. 1.

FIG. 6 is an end view of the single drive positioning system of FIG. 1.

FIG. 7 is a side view of the single drive positioning system of FIG. 1.

FIG. 8 is an exploded, fragmentary view of the single drive positioning system of FIG. 1.

FIG. 9 is a fragmentary, cross-sectional view of the single drive positioning system of FIG. 1.

FIG. 10 is a perspective view of a one-way bearing forming a part of the single drive positioning system of FIG. 1.

FIG. 11 is a schematic, side view of a mass analysis system according to some embodiments.

FIG. 12 is a front perspective view of a single drive positioning system according to further embodiments.

FIG. 13 is a rear perspective view of the single drive positioning system of FIG. 12.

FIG. 14 is a front view of the single drive positioning system of FIG. 12.

FIG. 15 is a front view of a single drive positioning system according to further embodiments.

FIG. 16 is a rear view of the single drive positioning system of FIG. 15.

### DETAILED DESCRIPTION

Conventional dual axis positioning systems (e.g., X-Y stages) typically require two or more motors or other powered actuators (e.g., gear changers). However, these motors and actuators may add undesirable cost, size and/or weight to the dual axis positioning system.

Single drive positioning systems according to embodiments of the present technology address one or more of these problems by eliminating the need for multiple motors and/or other powered actuators while providing effective multi-axis positioning functionality. A single drive positioning system according to the technology may include a single motor that selectively rotates a drive shaft in each of a first direction and an opposing second direction (e.g., clockwise and counterclockwise). A first worm screw and a second worm screw are mounted on the drive shaft. The first worm screw is meshed with a first worm wheel to form a first worm drive. The second worm screw is meshed with a second worm wheel to form a second worm drive. The first worm drive is configured to adjust a position of an object (e.g., a support platform and/or a component such as an ICP torch) along or about a first displacement axis. The second worm drive is configured to adjust a position of the object along or about a second displacement axis. Linkages may be provided between the first and second worm drives and the object.

A first overrunning clutch (e.g., a one-way bearing) is provided between the drive shaft and the first worm screw. A second overrunning clutch (e.g., a one-way bearing) is provided between the drive shaft and the second worm screw. The first and second overrunning clutches are mounted in opposing orientations such that: a) when the drive shaft is driven in the first direction, the first overrunning clutch transfers torque from the drive shaft to the first worm screw to rotate the first worm screw, and the second overrunning clutch permits the drive shaft to rotate freely within the second worm screw; and b) when the drive shaft is driven in the second direction, the second overrunning clutch transfers torque from the drive shaft to the second worm screw to rotate the second worm screw, and the first overrunning clutch permits the drive shaft to rotate freely within the first worm screw. As a result, the first worm drive is driven by the motor when the drive shaft is driven in the first direction, but not when the drive shaft is driven in the second direction. Similarly, the second worm drive is driven by the motor when the drive shaft is driven in the second direction, but not when the drive shaft is driven in the first direction. Accordingly, the object is repositioned along or about the first displacement axis by driving the drive shaft in the first direction using the motor, and is repositioned along or about the second displacement axis by driving the drive shaft in the second direction using the same motor, and no additional actuators (e.g., a gear changer) are required.

A single drive positioning system according to embodiments of the present technology may be incorporated into a mass analysis system to selectively position an ICP torch relative to an inlet of a sample introduction element. In other embodiments, a positioning system may be used to selectively position an ICP torch in an optical emission spectroscopy (OES) system. However, embodiments are not limited to use with ICP torches. Embodiments of the positioning system described herein may be included as a component of any system or apparatus.

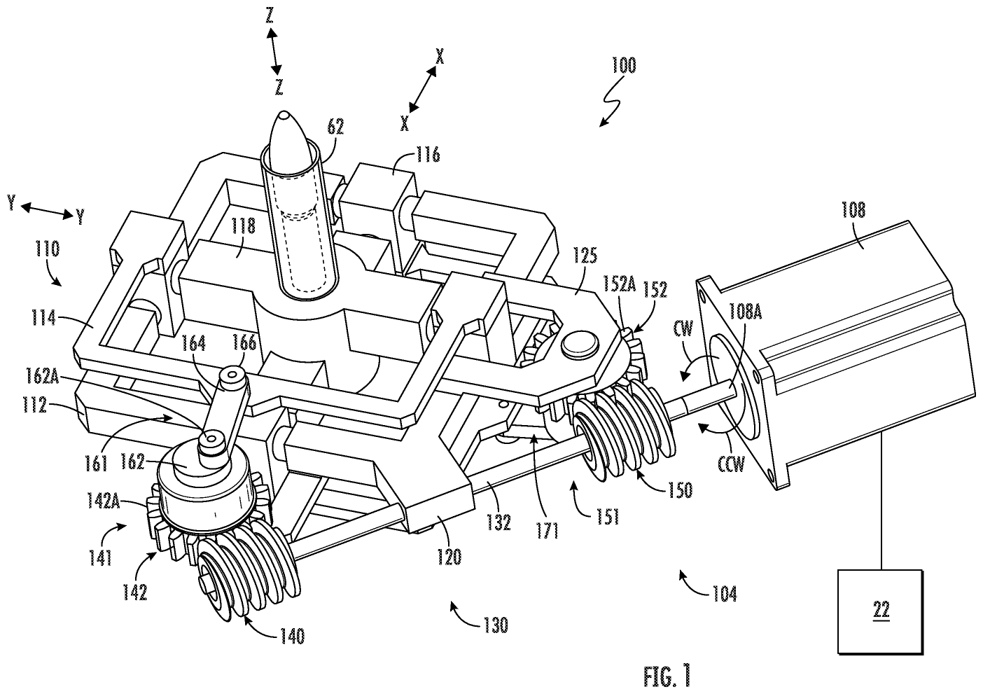

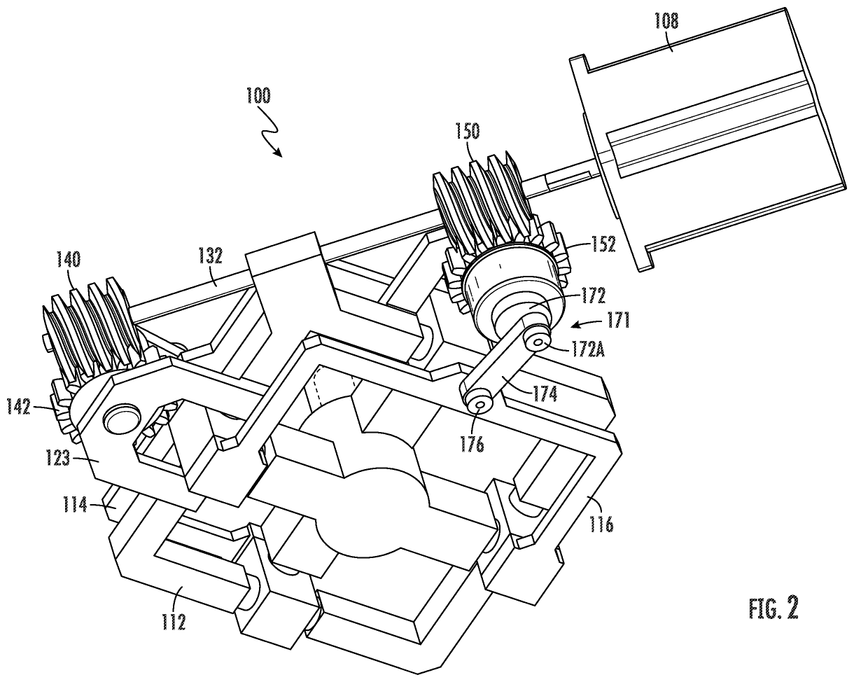

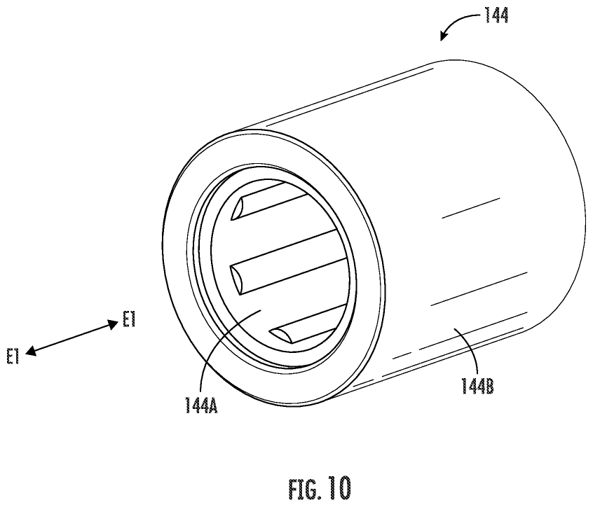

With reference to FIGS. 1-10, a single drive positioning stage or system 100 according to some embodiments is shown therein. The single drive positioning stage or system 100 includes a drive system 104 and a bearing system 110. The drive system 104 includes a motor 108, a transmission system 130, and a controller 22.

The single drive positioning system 100 is configured and operable to adjust (i.e., move, displace, or reposition) the spatial position of an object 62 linearly along a first displacement axis X-X and to adjust the spatial position of the object 62 linearly along a second displacement axis Y-Y. The axes X-X and Y-Y extend transverse to one another. In the example embodiment, the axes X-X and Y-Y are perpendicular, but other configurations may be provided. The illustrated object 62 is an ICP torch; however, it will be appreciated that the single drive positioning system 100 can be used with alternative objects. Additionally, in some embodiments, the object 62 may be a device, such as a torch box, that includes the ICP torch and other components such that the single drive positioning system 100 moves the entire device, including the ICP torch.

The bearing system 110 (FIGS. 1-3) is a dual axis linear slide bearing system. The bearing system 110 includes a bearing frame 112, a first guide member, yoke or shuttle 114, a second guide member, yoke or shuttle 116, and a platform, holder, support or carrier 118. In some embodiments, the components 112, 114, 116, 118 are each substantially rigid and may be formed of any suitable materials (e.g., metal and/or polymeric).

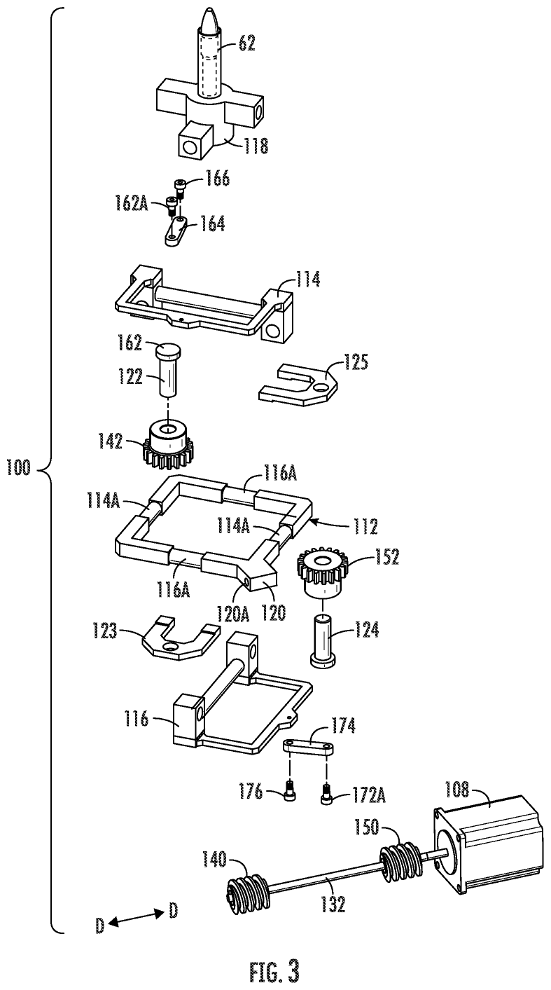

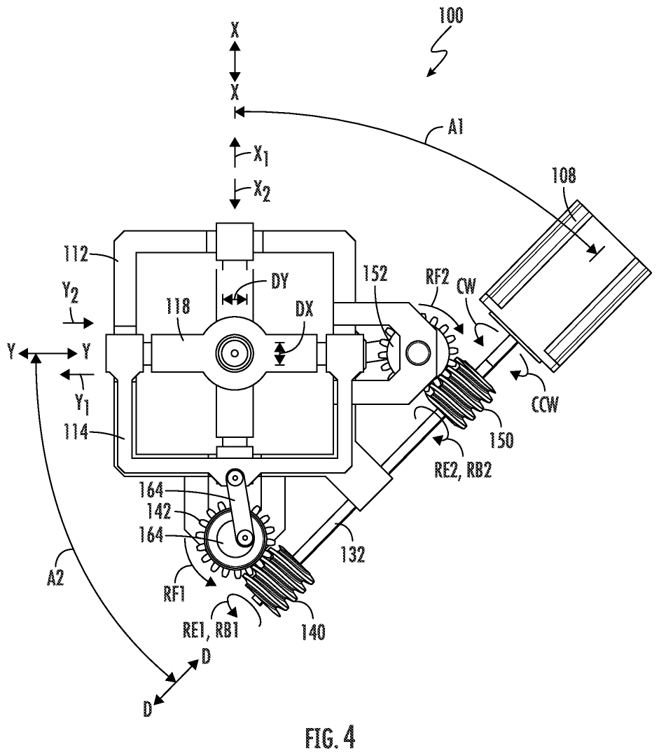

The bearing frame 112 (FIG. 3) includes opposed X-axis rails 114A and opposed Y-axis rails 116A. The guide member 114 is slidably mounted on the rails 114A to enable the guide member 114 to translate along the axis X-X in each of a forward direction X1 and an opposing rearward direction X2 (FIG. 4). In some embodiments, the guide member 114 is constrained to linear movement relative to the frame 112 along the axis X-X. Similarly, the guide member 116 is slidably mounted on the rails 116A to enable the guide member 116 to translate along the axis Y-Y in each of a forward direction Y1 and an opposing rearward direction Y2. In some embodiments, the guide member 116 is constrained to linear movement relative to the frame 112 along the axis Y-Y. In some embodiments, the guide members 114, 116 and the carrier 118 are constrained from moving along the Z-axis Z-Z (i.e., perpendicular to each of the axis X-X and the axis Y-Y) relative to the bearing frame 112. In the example shown, the X-axis rails 114A and the Y-axis rails 116A are integral parts of the bearing frame 112. However, embodiments are not limited to an integral arrangement. For example, the rails 114A, 116A may be independently supported.

The bearing frame 112 also includes a drive shaft mount 120 (including a drive shaft bore 120A; FIG. 3), a first worm wheel mount 123, and a second worm wheel mount 125. The mounts 120, 123, 125 are each fixed in position relative to the bearing frame 112. In some embodiments and as illustrated, the mounts 120, 123, 125 are each integral features formed on the bearing frame 112 or affixed (directly or indirectly) to the bearing frame 112.

The motor 108 has an output 108A. The motor 108 may be any suitable type of motor. In some embodiments, the motor is an electric motor. In some embodiments, the motor is a rotary motor (e.g., a rotary electric motor) that generates a torque at or via the output 108A. In some embodiments, the motor is an electric servo motor. In some embodiments, the motor is an electric stepper motor.

The transmission system 130 includes a drive shaft 132, a first worm drive 141, a second worm drive 151, a first linkage 161, and a second linkage 171. In some embodiments and as illustrated, the first and second linkages 161, 171 are each rotary-to-linear motion mechanisms.

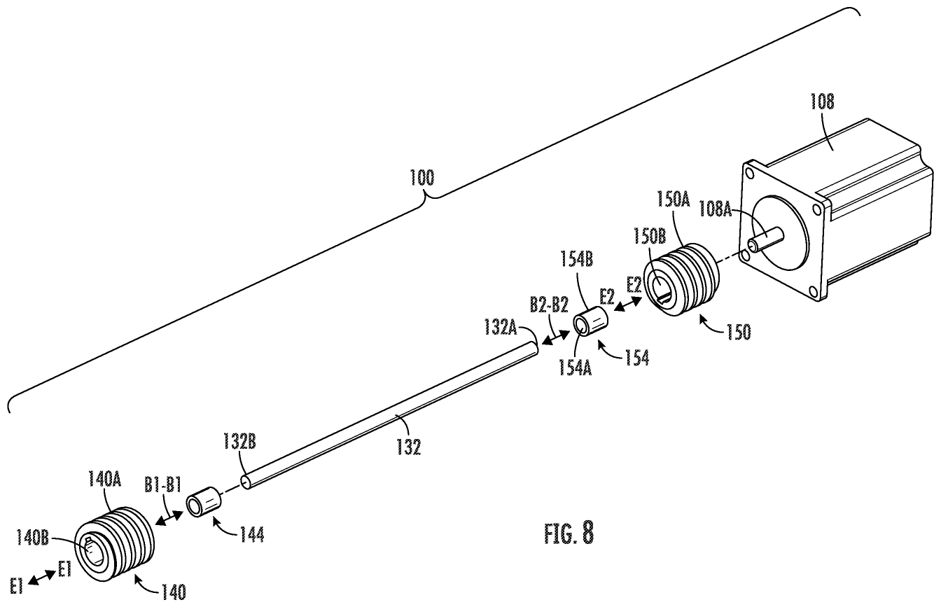

The drive shaft 132 (FIGS. 4 and 8) extends from a proximal end 132A to a distal end 132B and has a longitudinal drive shaft axis D-D. In some embodiments, the drive shaft 132 is unitary, and in some embodiments, the drive shaft 132 is monolithic. In some embodiments, the drive shaft 132 is substantially rigid. The drive shaft 132 may be formed of any suitable material (e.g., metal or polymeric material).

The proximal end 132A is connected to (e.g., affixed to or integral with) the motor output 108A such that the motor output 108A can selectively forcibly drive the drive shaft 132 about the drive shaft axis D-D in each of a clockwise rotational direction CW and an opposing counterclockwise rotational direction CCW (FIG. 1).

In some embodiments, the motor output 108A is configured and operated to directly impart these rotational drives (e.g., the motor output 108A is a rotary torque output). However, in other embodiments, an intermediate transmission mechanism may be provided between the motor output 108A and the drive shaft 132. For example, a gear reduction may be provided between the motor output 108A and the drive shaft 132. By way of further example, the motor output 108A may be a non-rotary output (e.g., a linear drive output) and a conversion mechanism (e.g., a linear-to-rotary mechanism) may be provided between the motor output 108A and the drive shaft 132 to convert the linear motor output to rotational drive on the drive shaft 132. In some embodiments, a belt drive, bevel gears, or another transmission device may be provided between the motor output and the drive shaft 132 to enable a different position and/or orientation of the motor 108 relative to the drive shaft 132.

The first worm drive 141 (FIG. 1) includes a first worm screw 140, a first worm wheel 142, and a first overrunning clutch 144. In some embodiments and as illustrated, the first overrunning clutch 144 is a one-way bearing 144.

The first worm screw 140 has a worm screw axis E1-E1 (FIG. 8). The worm screw 140 has a helical outer thread 140A that winds substantially coaxially about the axis E1-E1. The worm screw 140 also has an internal passage or bore 140B that extends substantially coaxially about the axis E1-E1.

The first bearing 144 (FIGS. 8-10) is radially interposed between the drive shaft 132 and the first worm screw 140. The first bearing 144 has a bearing axis B1-B1 and includes an inner race 144A and an outer race 144B. The inner race 144A is mounted on, coupled to or affixed to the drive shaft 132 to rotate therewith. For example, the inner race 144A may be secured to the drive shaft 132 by an interference fit, fastener, interlock, and/or adhesive. The outer race 144B is mounted on, coupled or affixed to the worm screw 140 in the bore 140B such that the worm screw 140 rotates with the outer race 144B. For example, the outer race 144B may be secured to the worm screw 140 by an interference fit, fastener, interlock, and/or adhesive.

The first bearing 144 is a one-way bearing that allows the inner race 144A to spin substantially freely relative to the outer race 144B about the axis B1-B1 in a first direction RB2, and couples or locks the inner race 144A to the outer race 144B when the inner race 144A is rotated about the axis B1-B1 in the opposite direction RB1. That is, the torque is transferred between the races 144A, 144B when the race 144A is rotated in one prescribed direction, and torque is not transferred between the races 144A, 144B when the race 144A is rotated in the opposite direction. One-way bearings of this type may be referred to as a unidirectional bearing, unidirectional clutch, one-way bearing, or one-way clutch. In some embodiments, the first bearing 144 is a one-way needle bearing.

The mounting arrangement between the first bearing 144 and the drive shaft 132 is also constructed such that the axial position of the worm screw 140 along the length of the drive shaft 132 is fixed.

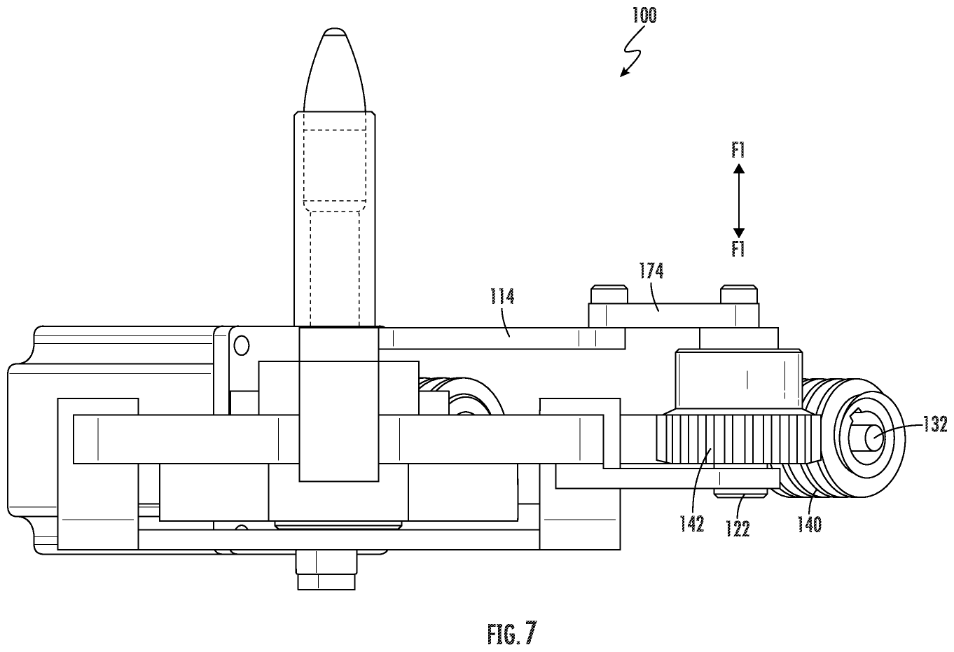

The first worm wheel 142 has a worm wheel axis F1-F1 (FIG. 7). The worm wheel 142 has teeth 142A distributed circumferentially about and coaxial with the axis F1-F1 (e.g., like a spur gear). The worm wheel 142 is mounted on the worm wheel mount 123 by an axle or pin 122 for rotation about the worm axis F1-F1.

The teeth 142A are meshed with the worm screw thread 140A to enable rotation of the worm screw 140 in the direction RE1 (FIG. 4) to drive rotation of the worm wheel 142 in a corresponding direction RF1 (FIG. 4). The worm screw axis of rotation E1-E1 is substantially perpendicular to the worm wheel axis of rotation F1-F1.

The second worm drive 151 (FIG. 1) includes a second worm screw 150, a second worm wheel 152, and a second overrunning clutch 154. The second worm drive 151, the second worm screw 150, the second worm wheel 152, and the second overrunning clutch 154 are constructed and operate in the same manner as the worm drive 141, the worm screw 140, the worm wheel 142, and the overrunning clutch 144, except as follows.

The second worm screw 150 has a worm screw axis E2-E2 (FIG. 8). The worm screw 150 has a helical outer thread 150A that winds substantially coaxially about the axis E2-E2. The worm screw 150 also has an internal passage or bore 150B that extends substantially coaxially about the axis E2-E2.

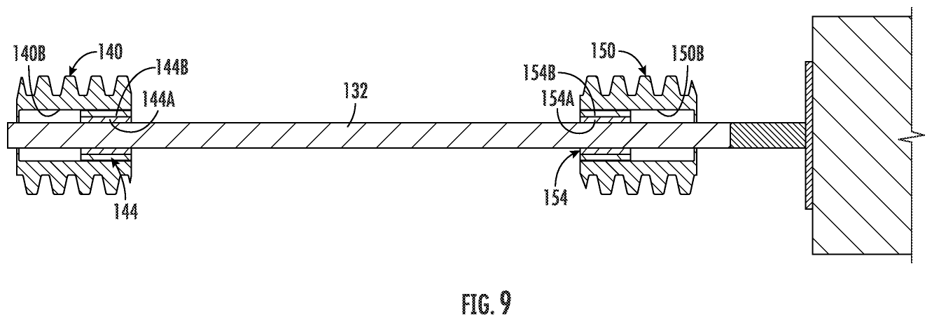

The second bearing 154 (FIGS. 8 and 9) is radially interposed between the drive shaft 132 and the second worm screw 150. The second bearing 154 has a bearing axis B2-B2 and includes an inner race 154A and an outer race 154B. The inner race 154A is mounted on, coupled to or affixed to the drive shaft 132 to rotate therewith. For example, the inner race 154A may be secured to the drive shaft 132 by an interference fit, fastener, interlock, and/or adhesive. The outer race 154B is mounted on, coupled to or affixed to the worm screw 150 in the bore 150B such that the worm screw 150 rotates with the outer race 154B. For example, the outer race 154B may be secured to the worm screw 150 by an interference fit, fastener, interlock, and/or adhesive.

The second bearing 154 is a one-way bearing as described above for the first bearing 144. The second bearing 154 allows the inner race 154A to spin substantially freely relative to the outer race 154B about the axis B2-B2 in a first direction RB1, and couples or locks the inner race 144A to the outer race 144B when the inner race 144A is rotated about the axis B2-B2 in the opposite direction RB2. The second bearing 154 is constructed and operates in the same manner as the first bearing 144, except that the locked rotation direction RB2 is opposite the locked rotation direction RB1 of the first bearing 144. That is, the first bearing 144 and the second bearing 154 are mounted on the drive shaft 132 with opposite orientations.

The mounting arrangement between the second bearing 154 and the drive shaft 132 is also constructed such that the axial position of the worm screw 150 along the length of the drive shaft 132 is fixed.

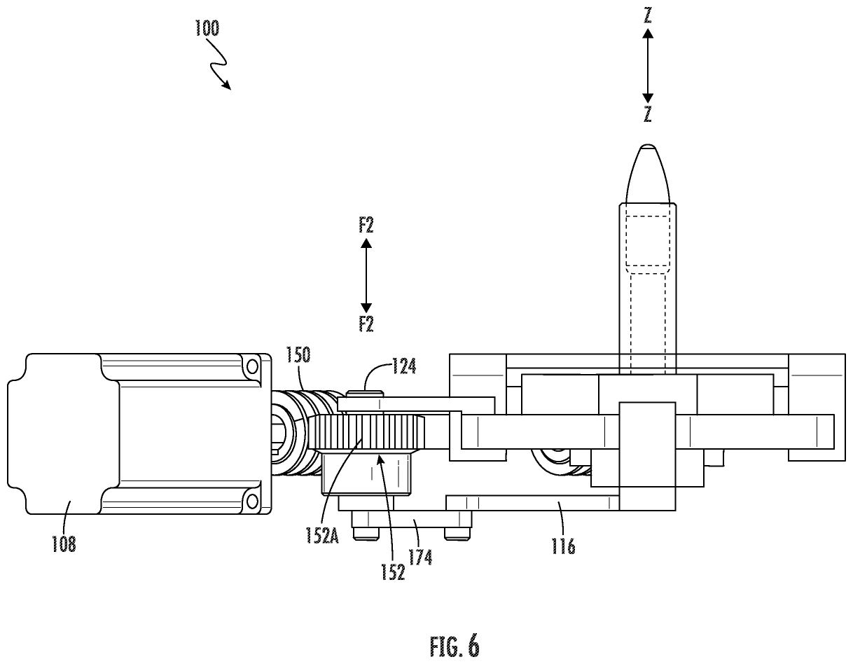

The second worm wheel 152 has a worm wheel axis F2-F2 (FIG. 6). The worm wheel 152 has teeth 152A distributed circumferentially about and coaxial with the axis F2-F2 (e.g., like a spur gear). The worm wheel 152 is mounted on the worm wheel mount 125 by an axle or pin 124 for rotation about the worm axis F2-F2.

The teeth 152A are meshed with the worm screw thread 150A to enable rotation of the worm screw 150 in the direction RE2 (FIG. 4) to drive rotation of the worm wheel 152 in a corresponding direction RF2 (FIG. 4). The worm screw axis of rotation E2-E2 is substantially perpendicular to the worm wheel axis of rotation F2-F2.

The first linkage 161 (FIGS. 1 and 4) is a slider-crank mechanism including a crank 162 and a connecting member or rod 164. The crank 162 is secured (e.g., affixed or integral with) the first worm wheel 142 for rotation therewith about the worm wheel axis F1-F1. A proximal end of the connecting rod 164 is pivotably coupled to the crank 162 by a screw or pin 162A. A distal end of the connecting rod 164 is pivotably coupled to the guide member mount 114 by a screw or pin 166.

The axis of the pin 162A is offset from (eccentric relative to) the worm wheel axis F1-F1. This causes the connecting rod 164 to translate (in some cases, reciprocate) in the directions X1 and X2. The crank 162 pushes the guide member 114 in the direction X1 or pulls the guide member 114 in the direction X2, depending on the angular orientation position of the crank 162. As a result, the distance between the axis F1-F1 and the guide member 114 varies as the crank 162 is rotated. Because the position of the worm wheel 142 relative to the frame 112 is fixed, this causes the guide member 114 to correspondingly translate relative to the frame 112 in the directions X1 and X2 along the axis X-X.

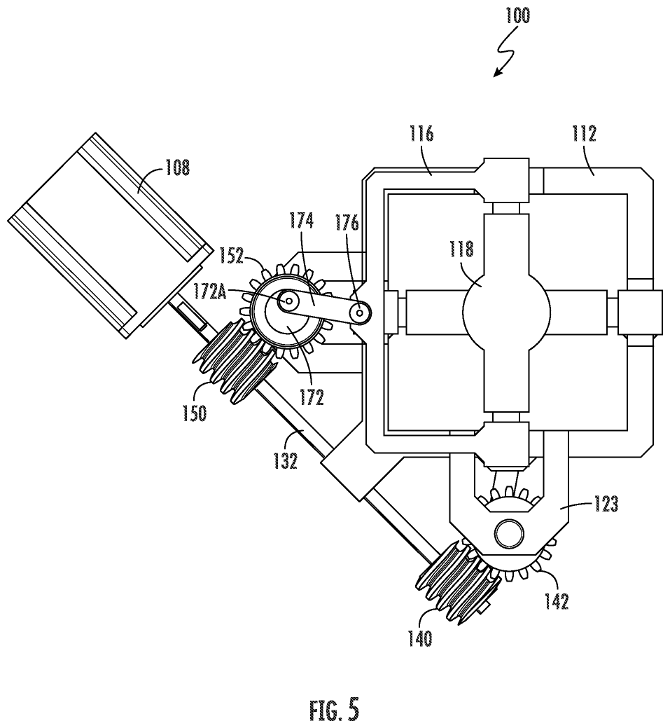

The second linkage 171 (FIGS. 1 and 5) is also a slider-crank mechanism that is constructed and operable in the same manner as described above for the first linkage 161. The second linkage 171 includes a crank 172 and a connecting member or rod 174. The crank 172 is secured (e.g., affixed or integral with) the second worm wheel 152 for rotation therewith about the worm wheel axis F2-F2. A proximal end of the connecting rod 174 is pivotably coupled to the crank 172 by a screw or pin 172A. A distal end of the connecting rod 174 is pivotably coupled to the guide member 116 by a screw or pin 176.

The axis of the pin 172A is offset from (eccentric relative to) the worm wheel axis F2-F2. This causes the connecting rod 174 to translate (in some cases, reciprocate) in the directions Y1 and Y2. The crank 172 pushes the guide member 116 in the direction Y1 or pulls the guide member 116 in the direction Y2, depending on the position of angular orientation of the crank 172. As a result, the distance between the axis F2-F2 and the guide member 116 varies as the crank 172 is rotated. Because the position of the worm wheel 152 relative to the frame 112 is fixed, this causes the guide member 116 to correspondingly translate relative to the frame 112 in the directions Y1 and Y2 along the axis Y-Y.

With reference to FIG. 4, the single drive positioning system 100 may be used as follows. In general, and as described in more detail below, the single drive positioning system 100 is operable to adjust the X-axis and Y-axis positions of the carrier 118 by operating only the single motor 108, without the need for additional actuators, e.g., gear changers. More particularly, the position of the carrier 118 along the X-axis is adjusted by rotating the drive shaft 132 in the clockwise direction CW, and the position of the carrier 118 along the Y-axis is adjusted by rotating the drive shaft 132 in the counterclockwise direction CCW. In the description below, the controller 22 is used to control operation of the motor 108. However, in other embodiments, the motor 108 may be controlled manually, for example.

In order to adjust the X-axis position of the carrier 118, the controller 22 operates the motor 108 to drive the drive shaft 132 in the clockwise direction CW. The inner race 144A of the first one-way bearing 144 and the inner race 154A of the second one-way bearing 154 are thereby driven to rotate in the clockwise direction CW.

Because the second bearing 154 is free-spinning in the clockwise direction CW (i.e., the direction RB1) and rotation of the second worm screw 150 is resisted by the second worm wheel 152, the drive shaft 132 spins independently of the second worm screw 150 and does not drive the second worm drive 151. The Y-axis position of the carrier 118 therefore remains unchanged.

Because the first bearing 144 is locking in the clockwise direction CW (i.e., in the direction RB1), the first bearing 144 imparts the torque from the drive shaft 132 to the first worm screw 140, thereby rotating the worm screw 140 in the direction RE1. The rotation of the worm screw 140 in turn drives the first worm wheel 142 to rotate about the axis F1-F1 in the direction RF1. The crank 162 rotates with the worm wheel 142, causing the connecting rod 164 to translate along the axis X-X. The bearing system 110 isolates the movement of the distal end of the connecting rod 164 to the axis X-X. The translation of the connecting rod 164 pushes or pulls the guide member 114 with respect to the bearing frame 112, thereby adjusting the X-axis position of the carrier 118. The X-axis position of the carrier 118 can be set as desired in this manner.

In order to adjust the Y-axis position of the carrier 118, the controller 22 operates the motor 108 to drive the drive shaft 132 in the counterclockwise direction CCW. The inner race 144A of the first one-way bearing 144 and the inner race 154A of the second one-way bearing 154 are thereby driven to rotate in the counterclockwise direction CCW.

Because the first bearing 144 is free-spinning in the counterclockwise direction CCW (i.e., in the direction RB2) and rotation of the first worm screw 140 is resisted by the first worm wheel 142, the drive shaft 132 spins independently of the first worm screw 140 and does not drive the first worm drive 141. The X-axis position of the carrier 118 therefore remains unchanged.

Because the second bearing 154 is locking in the counterclockwise direction CCW (i.e., in the direction RB2), the second bearing 154 imparts the torque from the drive shaft 132 to the second worm screw 150, thereby rotating the second worm screw 150 in the direction RE2. The rotation of the second worm screw 150 in turn drives the second worm wheel 152 to rotate about the axis F2-F2 in the direction RF2. The crank 172 rotates with the second worm wheel 152, causing the connecting rod 174 to translate along the axis Y-Y. The bearing system 110 isolates the movement of the distal end of the connecting rod 174 to the axis Y-Y. The translation of the connecting rod 174 pushes or pulls the guide member 114 with respect to the bearing frame 112, thereby adjusting the Y-axis position of the carrier 118. The Y-axis position of the carrier 118 can be set as desired in this manner.

As the first crank 162 is rotated a full revolution (i.e., 360 degrees) about the axis, the connecting rod 164 will travel in the direction X1, then travel back in the direction X2, and will repeat this sequence for each subsequent revolution. Accordingly, the rotation of the crank 162 causes the connecting rod 164 to reciprocate. The slider-crank mechanism 161 provides a range of adjustment DX (FIG. 4) of the carrier 118 along the axis X-X corresponding to the full excursion distance from the fully extended position of the connecting rod 164 to the fully retracted position of the connecting rod 164. The second slider-crank mechanism 171 operates in the same manner to provide a range of adjustment DY (FIG. 4) of the carrier 118 along the axis Y-Y corresponding to the full excursion distance from the fully extended position of the connecting rod 174 to the fully retracted position of the connecting rod 174. The amount or range of motion or travel of the carrier 118 along each axis X-X, Y-Y can be set by selecting a corresponding eccentricity for the crank 162, 172. In some embodiments, each range of adjustment DX, DY is in the range of from about 8 mm to 12 mm (e.g., +/−4 mm to +/−6 mm). The ranges of adjustment DX, DY may be the same or different from one another. In some embodiments, each range of adjustment may be set by selecting a crank 162, 172 having a corresponding eccentricity from its rotation axis F1-F1, F2-F2.

In some embodiments, the controller 22 programmatically and automatically controls the motor 108 to adjust and set each of the X-axis and Y-axis positions of the carrier 118.

Thus, the single drive positioning system 100 enables an operator to independently move the carrier 118 (or other object) along two different axes with a single drive motor 108, and without any additional actuator(s) (e.g., a gear changer) by switching the direction the drive shaft 132 is driven (i.e., the direction in which torque from the motor output 108A is applied). When the drive shaft 132 is driven in the clockwise direction CW, the first worm wheel 142 is thereby driven and the rotational motion of the first worm wheel 142 is converted to linear motion by the slider-crank mechanism 161. When the drive shaft 132 is driven in the counterclockwise direction CCW, the second worm wheel 152 is thereby driven and the rotational motion of the second worm wheel 152 is converted to linear motion by the slider-crank mechanism 171.

As discussed above, in some embodiments, the axial positions of the worm screws 140, 150 along the length of the drive shaft 132 are rigidly fixed. Additionally, in some embodiments, the axial position of the drive shaft 132 relative to the worm wheels 142, 152 is fixed. The first worm drive 141 and the second worm drive 151 each form self-locking worm gear sets. As a result, the worm drives 141, 151 are not back drivable. That is, the worm screw 140 cannot be driven to rotate about the drive shaft axis D-D by torque from the worm wheel 142, and the worm screw 150 cannot be driven to rotate about the drive shaft axis D-D by torque from the worm wheel 152. This aspect prevents the adjustment along one axis (i.e., the X-axis or the Y-axis) from being changed when the drive shaft 132 is being driven to execute an adjustment along the other axis. This aspect may be important to prevent unintended movement of the carrier 118 when external forces (e.g., gravity or a spring force) act on the carrier 118. By nature, a one-way bearing cannot restrict inertial motion (the output moving ahead of the input) in the one-way bearing's free-spin direction. Also, although a one-way bearing does not allow back driving in its direction of lock when static, when the drive shaft 132 is driven in the opposing direction the “locked” position of the one-way bearing is essentially rotating with the drive shaft 132. These problems are addressed by the self-locking of the worm drives 141, 151.

The worm drives 141, 151 may also be configured to provide gear reduction from the motor output 108A to the slider cranks 161, 171.

In some embodiments and as shown, the drive shaft axis D-D forms an oblique angle A1 (FIG. 4) with the first displacement axis X-X and an oblique angle A2 (FIG. 4) with the second displacement axis Y-Y. In some embodiments, the angles A1, A2 are each 45 degrees. However, in other embodiments the oblique angles A1, A2 may be more or less than 45 degrees and, in some embodiments, may be different from one another.

In some embodiments and as shown, the drive shaft axis D-D is perpendicular to each of the worm wheel axes F1-F1, F2-F2.

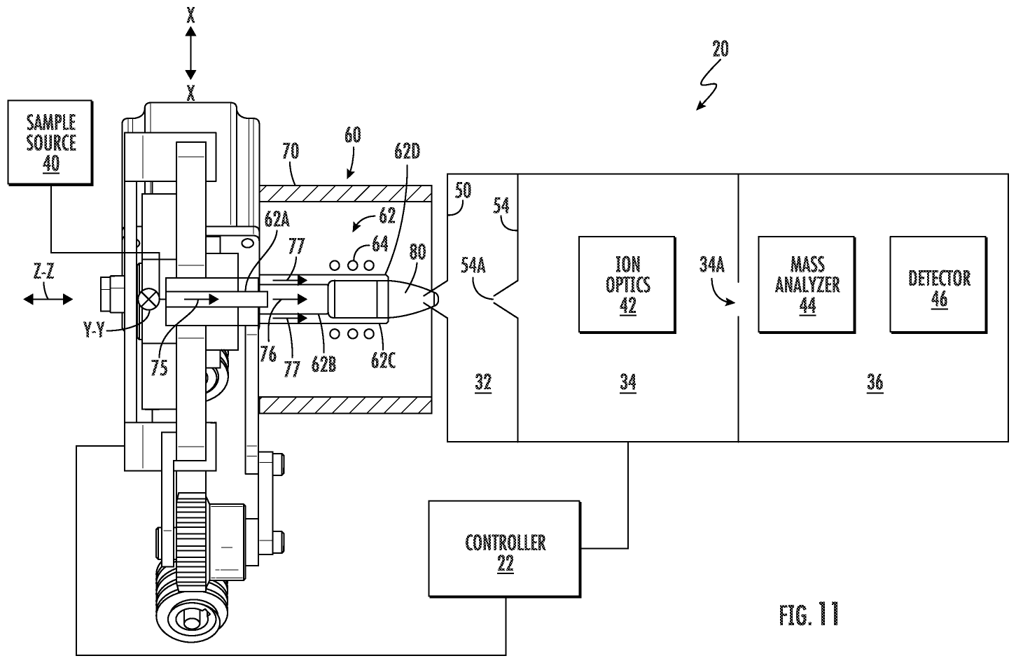

With reference to FIG. 11, a single drive positioning system 100 as discussed above may be incorporated into a mass analyzer system 20. The illustrated mass analyzer system 20 is an inductively coupled plasma mass spectroscopy (ICP-MS) analyzer. The ICP-MS analyzer system 20 may be constructed and operated as disclosed in U.S. Pat. No. 9,105,457 to Badiei et al., for example, the disclosure of which is incorporated herein by reference.

The mass analyzer system 20 includes the single drive positioning system 100, a torch assembly 60, a sample source 40, a sampler 50, a skimmer 54, ion optics 42, a mass analyzer 44, a detector 46, an interface vacuum chamber 32, an ion optics vacuum chamber 34, a mass analyzer vacuum chamber 36, and the controller 22.

The torch assembly 60 includes an ICP torch 62 and a substrate, subframe, or housing 70 supporting the torch 62. The torch 62 includes an injector 62A, an intermediate or auxiliary tube 62B formed of quartz, for example), an outer or plasma tube 62C, and an induction coil 64 (e.g., an RF energy coil). The torch assembly 60 may further include electrical connections for the induction coil 64, a clamp or mount for securing the torch 62 to the housing 70, connections for introducing the sample and gas streams discussed below to the torch 62, and/or other components.

The sample source 40 (e.g., a nebulizer) supplies a sample stream 75 including a sample contained in a carrier gas (e.g., argon) through the injector 62A into the auxiliary tube 62B. An auxiliary gas flow 76 (e.g., argon) is also introduced into the auxiliary tube 62B. A plasma gas flow 77 (e.g., argon; typically having a higher flow rate auxiliary gas flow 76) is provided in the plasma tube 62C.

In use, a plasma 80 is generated by the induction coil 64 from the auxiliary gas flow 76. The plasma 80 is generated close to atmospheric pressure by the induction coil 64 encircling the plasma tube 62C. Plasma 80 can also be generated in any other suitable fashion known in the art. The plasma 80 atomizes the sample stream 75 and ionizes the atoms, creating a mixture of ions and free electrons. A portion of the plasma 80 is sampled through (i.e., travels or flows through) an orifice or inlet 52 in the sampler 50. The sampler 50 and the skimmer 54 may form opposing walls of the interface vacuum chamber 32. The interface vacuum chamber 32 may be evacuated to a moderately low pressure (e.g. 1-5 Torr) by a vacuum pump (not shown). The skimmer 54 has an orifice 54A which leads to the ion optics vacuum chamber 34. The ion optics vacuum chamber 34 is evacuated to a lower pressure (e.g., 10⁻³ Torr or less) than that of the interface vacuum chamber 32. The ion optics vacuum chamber 34 includes the ion optics 42 for focusing the ion beam.

The ions emerging from the ion optics 42 travel through an orifice 34A in a wall and into the mass analyzer vacuum chamber 36. In certain embodiments, the mass analyzer vacuum chamber 36 may be part of the ion optics vacuum chamber 34. The mass analyzer 44 is disposed in the mass analyzer vacuum chamber 36 downstream of the inlet 52. The mass analyzer 44 may be a quadrupole mass spectrometer, an ion trap, a magnetic sector analyzer, a time of flight analyzer, an ion mobility analyzer, or any other suitable mass analyzer known to those of skill in the art.

In use, ions from the plasma 80 travel with the plasma gas through the sampler orifice 52. Ions then pass through the skimmer aperture 54A, carried by the bulk gas flow. The ions are then charge separated, partly because of the diffusion of high mobility electrons and partly because of the ion optics 42 and the bias potentials thereon. The ions are focused by the ion optics 42 through orifice 34A and into the mass analyzer 44. The mass analyzer 44 is controlled to produce a mass spectrum for the sample being analyzed.

In other embodiments, the mass analyzer system 20 may include a second skimmer, e.g., as disclosed in U.S. Pat. No. 9,105,457 to Badiei et al., the disclosure of which is incorporated herein by reference in its entirety.

The torch assembly 60 is mounted on the carrier 118 of the single drive positioning system 100. The torch tip 62D of the torch 62 is positioned such that the plasma 80 is directed or aimed at the inlet 52 along a Z-axis. In order to increase the performance and detection precision of the mass analyzer system 20, the plasma 80 should be properly aligned with the inlet 52, which in some cases means centering the plasma 80 with the inlet 52, but in other cases may mean running the ICP-MS analyzer while altering the position of the plasma 80 with the positioning system 100 until the detection rate of the ICP-MS analyzer is above a desired threshold. The single drive positioning system 100 is operable to center or align the torch assembly, and thereby the torch 62 and the plasma 80 generated thereby, relative to the inlet 52. More particularly, the single drive positioning system 100 is arranged and configured to adjust (i.e., selectively reposition and set) the position of the tip 62D of the torch 62 along each of the X-axis and the Y-axis (which extend perpendicular to one another and the Z-axis) as described above. Thus, for example, the motor output 108A may be operated to drive the drive shaft 132 in the clockwise direction CW to move the torch assembly 60 along the X-axis, and the motor output 108A may be operated to drive the drive shaft 132 in the counterclockwise direction CCW to move the torch assembly 60 along the Y-axis, until the torch tip 62D is set at the desired X,Y coordinates for alignment.

In some embodiments, the controller 22 programmatically and automatically controls the motor 108 to adjust and set each of the X-axis and Y-axis positions of the torch tip 62D relative to the inlet 52 to achieve an alignment. In some embodiments, the operator or the controller 22 executes a calibration procedure. In the calibration procedure, the mass analysis system is operated to generate a plasma via the torch 62 and analyze a sample (e.g., a reference sample). The controller 22 (or operator) adjusts the X-axis and Y-axis positions of the torch assembly 60 while the sample is ionized by the torch 62 and monitors the detection signal from the detector 46. Based on the detection efficiency (signal optimization) at different torch X, Y positions, the controller 22 (or operator) determines when an optimal or desired alignment has been achieved.

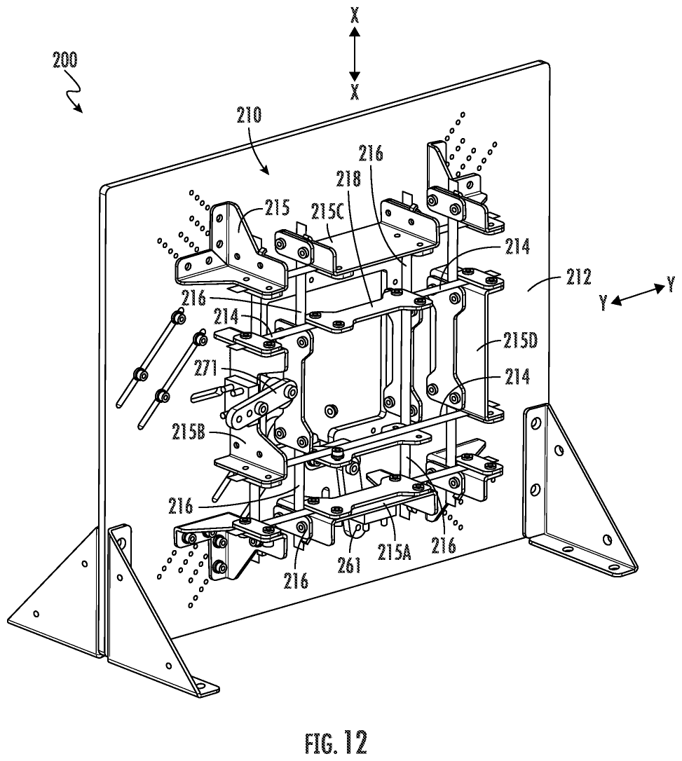

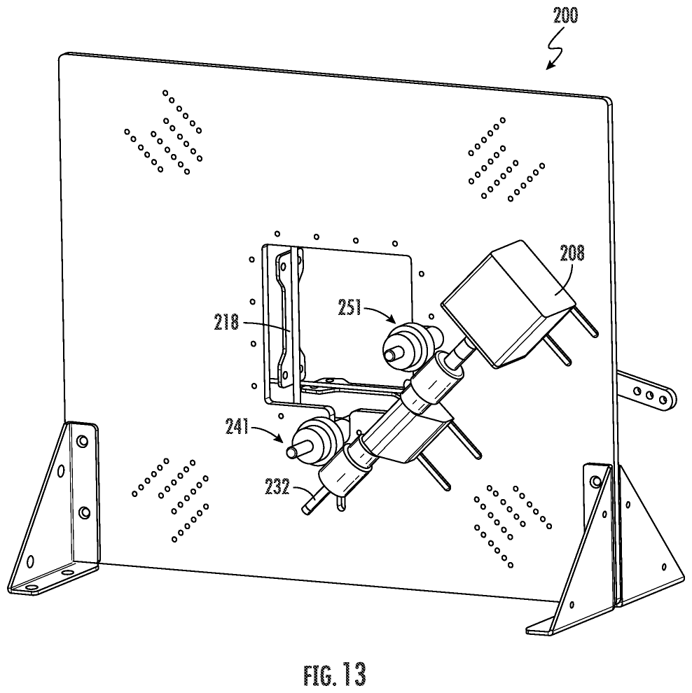

With reference to FIGS. 12-14, a single drive positioning system 200 according to further embodiments is shown therein. The system 200 may be constructed and operate in the same manner as the single drive positioning system 100 except as follows.

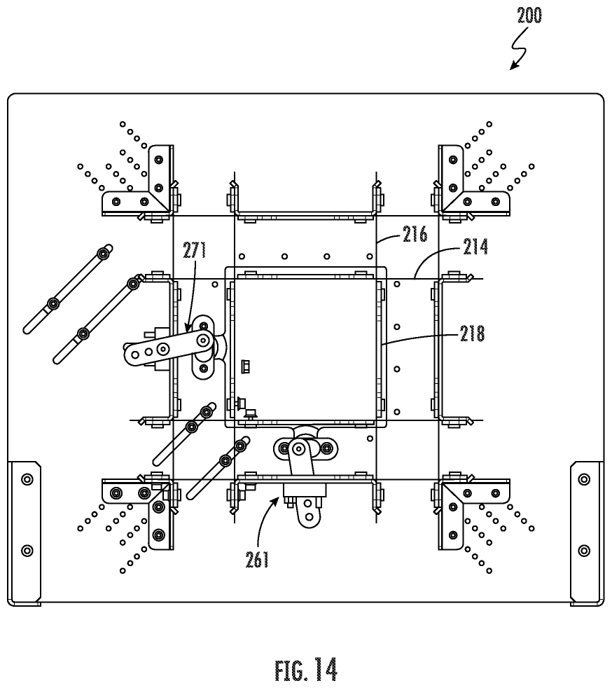

The single drive positioning system 200 includes a flexure bearing system 210 (FIGS. 12 and 14) in place of the linear bearing system 110. The flexure bearing system 210 includes a carrier 218, a frame 212, a first set of flexure members 214, and a second set of flexure members 216. The outer ends of the flexure members 214, 216 are each secured to the frame 212 by corresponding anchor brackets 215A-D. The inner ends of the flexure members 214, 216 are coupled to the carrier 218.

The flexure members 214, 216 are substantially rigid against deflection or bending along the Z-axis. The flexure members 214 are configured to deflect or bend resiliently along the X-axis. The flexure members 216 are configured to deflect or bend resiliently along the Y-axis. In this manner, the carrier 218 is effectively suspended or supported by the flexure members 214, 216 and constrained to displacement only along the X-axis and Z-axis.

The single drive positioning system 200 includes a motor 208, drive shaft 232, first worm drive 241, second worm drive 251, first linkage 261, and a second linkage 271 corresponding to the motor 108, drive shaft 132, first worm drive 141, second worm drive 151, first linkage 161, and a second linkage 171, respectively. It will be appreciated that the single drive positioning system 200 can be operated in the same or similar manner to the single drive positioning system 100 to position the carrier 218.

The flexure members 214, 216 may be formed of any suitable material such as metal or polymer.

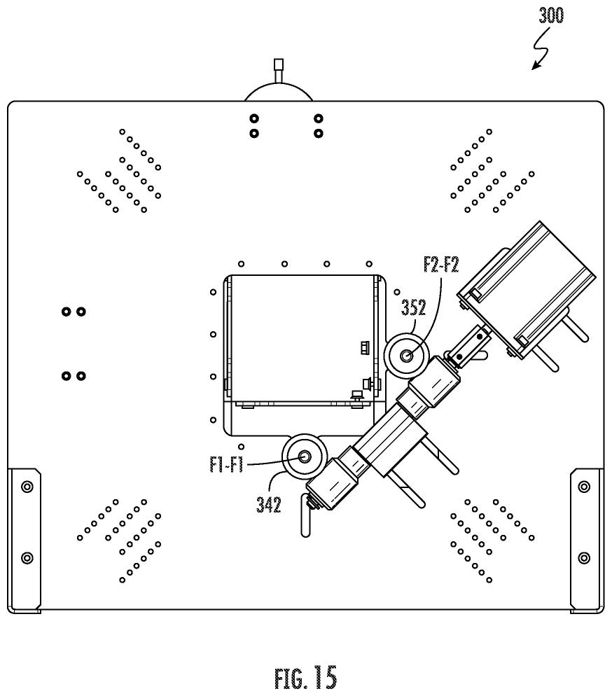

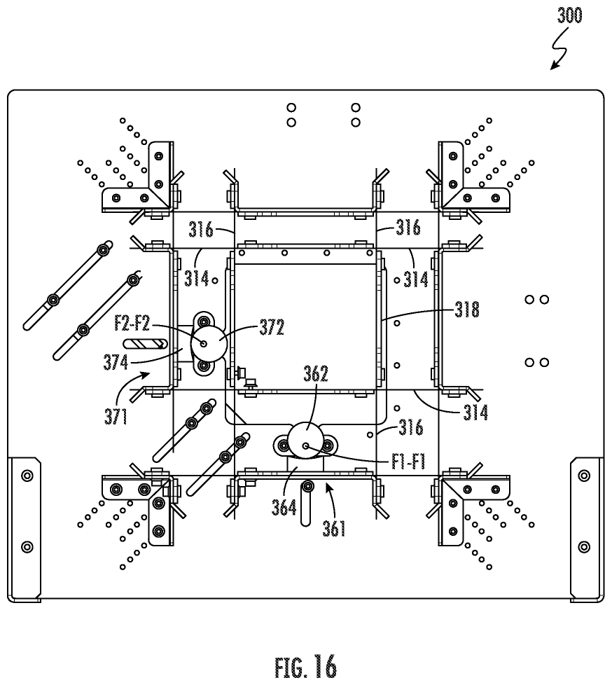

With reference to FIGS. 15 and 16 a single drive positioning system 300 according to further embodiments is shown therein. The system 300 may be constructed and operate in the same manner as the single drive positioning system 100 except as follows.

The single drive positioning system 300 includes a first cam and follower linkage 361 and a second cam and follower linkage 371 in place of the first and second slider-crank linkages 161, 171 to convert the rotary motion of the worm wheels 342 and 352 to translational X-axis and Y-axis movement of the carrier 318.

The first linkage 361 includes a first cam 362 fixed to the first worm wheel 342 for rotation therewith. The outer peripheral profile of the first cam 362 is eccentric about the rotation axis F1-F1 of the first worm wheel 342. A first follower 364 converts the movement of the cam 362 to translational movement of the carrier 318. The first follower 364 may be biased into engagement with the first cam 362 by the resilience of the flexure members 314 and/or a supplemental biasing mechanism (e.g., spring(s)), for example.

Likewise, the second linkage 371 includes a second cam 372 fixed to the second worm wheel 352 for rotation therewith. The outer peripheral profile of the second cam 372 is eccentric about the rotation axis F2-F2 of the second worm wheel 352. A second follower 374 converts the movement of the cam 372 to translational movement of the carrier 318. The second follower 374 may be biased into engagement with the second cam 372 by the resilience of the flexure members 316 and/or a supplemental biasing mechanism (e.g., spring(s)), for example.

While single drive positioning systems have been shown and described herein including a carrier, stage or platform that is displaced by the linkages (e.g., linkages 161, 171), in other embodiments an object to be positioned may be directly coupled to the guide members or linkages and the carrier, stage or platform may be omitted. In some embodiments, the object may have integral features to constrain movement of the object to the intended axis of adjustment.

Single drive positioning systems according to some embodiments may be configured to adjust the position of an object along different axes or relative to the axes in different ways (i.e., not translational adjustment along an X-axis and translational adjustment along a Y-axis). For example, the linkages between the worm wheels 142, 152 and the object may be configured to change a rotational (angular) position or attitude of the object about a displacement axis, or to translate the object along a Z-axis.

Single drive positioning systems as disclosed herein may be incorporated into apparatus other than ICP mass analyzers, such as other types of mass analyzers, other types of devices employing an ICP torch, other types of analytical instruments, and apparatus other than analytical instruments.

Single drive positioning systems as disclosed herein may include bearing systems of different configurations than those shown herein, including bearing systems other than dual-axis linear or flexure bearing systems.

A dual-axis single drive positioning system as disclosed herein can be used in combination to an additional or supplemental positioning system including a second motor or other actuator. For example, a single drive positioning system configured to adjust the position of an object along an X-axis and a Y-axis may be paired with a second drive system that adjusts the position of the object along a Z-axis, a rotational position of the object, or an attitude of the object.

Single drive positioning systems as disclosed herein may include additional intermediate gearing or linkages between the motor output and the object to be adjusted. For example, reduction gears may be provided between the motor output and the drive shaft, and/or between the worm wheel and the crank.

Other types of linkages may be provided between the worm wheels and the final outputs (e.g., the guide members 114, 116).

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art. For example, the illustrated system is described with respect to an ICP-MS, however the systems and method described herein may be used in with any type of sample analysis system using any suitable type of ionizer or mass spectrometer.

Embodiments of the controller 22 logic may take the form of an entirely software embodiment or an embodiment combining software and hardware aspects, all generally referred to herein as a “circuit” or “module.” In some embodiments, the circuits include both software and hardware and the software is configured to work with specific hardware with known physical attributes and/or configurations. Furthermore, controller logic may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or other storage devices.

The present technology has been described herein with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

The term “automatically” means that the operation is substantially, and may be entirely, carried out without human or manual input, and can be programmatically directed or carried out.

The term “programmatically” refers to operations directed and/or primarily carried out electronically by computer program modules, code and/or instructions.

The term “electronically” includes both wireless and wired connections between components.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. A single drive positioning system comprising:
a drive shaft;
a motor having a motor output connected to the drive shaft and operable to selectively rotate the drive shaft;
a first worm screw mounted on the drive shaft for rotation therewith; and
a second worm screw mounted on the drive shaft for rotation therewith.

2. The single drive positioning system of claim 1 including:
a first overrunning clutch between the first worm screw and the motor output; and
a second overrunning clutch between the second worm screw and the motor output.

3. The single drive positioning system of claim 2 wherein:
the motor is operable to rotate the drive shaft in each of a clockwise direction and a counterclockwise direction;
the first overrunning clutch is configured to drive the first worm screw in the clockwise direction when the drive shaft is driven in the clockwise direction, and to permit the drive shaft to rotate independently of the first worm screw when the drive shaft is driven in the counterclockwise direction; and
the second overrunning clutch is configured to drive the second worm screw in the counterclockwise direction when the drive shaft is driven in the counterclockwise direction, and to permit the drive shaft to rotate independently of the second worm screw when the drive shaft is driven in the clockwise direction.

4. The single drive positioning system of claim 3 wherein:
the first overrunning clutch includes a first one-way bearing coupling the first worm screw to the drive shaft; and
the second overrunning clutch includes a second one-way bearing coupling the second worm screw to the drive shaft.

5. The single drive positioning system of claim 4 wherein:
the first one-way bearing is radially interposed between the first worm screw and the drive shaft; and
the second one-way bearing is radially interposed between the second worm screw and the drive shaft.

6. The single drive positioning system of claim 5 wherein the first and second one-way bearings are one-way needle bearings.

7. The single drive positioning system of claim 3 including:
a first worm drive including the first worm screw and a first worm wheel intermeshed with the first worm screw; and
a second worm drive including the second worm screw and a second worm wheel intermeshed with the second worm screw.

8. The single drive positioning system of claim 7 wherein the first worm drive and the second worm drive are self-locking worm drives such that the first and second worm screws are not backwards drivable by the first and second worm wheels.

9. The single drive positioning system of claim 8 wherein the first and second worm screws are mounted on the drive shaft at axially fixed locations along the drive shaft.

10. The single drive positioning system of claim 7 including:
a first rotary-to-linear motion mechanism configured to be driven by rotation of the first worm wheel; and
a second rotary-to-linear motion mechanism configured to be driven by rotation of the second worm wheel.

11. The single drive positioning system of claim 10 wherein at least one of the first and second rotary-to-linear motion mechanisms includes a slider-crank mechanism including a crank and a reciprocating connecting member.

12. The single drive positioning system of claim 10 wherein at least one of the first and second rotary-to-linear motion mechanisms includes a cam mechanism including a cam and a cam follower.

13. The single drive positioning system of claim 10 including a slide bearing system including:
a frame;
a first guide member slidably mounted on the frame for movement along a first displacement axis; and
a second guide member slidably mounted on the frame for movement along a second displacement axis extending transverse to the first displacement axis;
wherein:
the first rotary-to-linear motion mechanism is configured to displace the first guide member along the first displacement axis when the first worm screw is driven in the clockwise direction; and
the second rotary-to-linear motion mechanism is configured to displace the second guide member along the second displacement axis when the second worm screw is driven in the counterclockwise direction.

14. The single drive positioning system of claim 10 including a flexure bearing system including:
a frame;
a carrier; and
at least one bendable flexure member connecting the carrier to the frame such that the carrier is movable along each of a first displacement axis and a second displacement axis extending transverse to the first displacement axis;
wherein:
the first rotary-to-linear motion mechanism is configured to displace the carrier along the first displacement axis when the first worm screw is driven in the clockwise direction; and
the second rotary-to-linear motion mechanism is configured to displace the carrier along the second displacement axis when the second worm screw is driven in the counterclockwise direction.

15. The single drive positioning system of claim 3, wherein the single drive positioning system is configured for use with an object, and is configured to:
displace the object along or about a first displacement axis when the first worm screw is driven in the clockwise direction; and
displace the object along or about a second displacement axis when the second worm screw is driven in the counterclockwise direction.

16. The single drive positioning system of claim 15 wherein:
the first displacement axis is a linear axis; and
the second displacement axis is a linear axis extending transverse to the first displacement axis.

17. The single drive positioning system of claim 16 wherein:
the motor is operable to rotate the drive shaft about a drive shaft axis; and
the drive shaft axis extends at an oblique angle to the first displacement axis and at an oblique angle to the second displacement axis.

18. A method for positioning an object, the method comprising:
providing a single drive positioning system comprising:
a drive shaft;
a motor having a motor output connected to the drive shaft and operable to selectively rotate the drive shaft;
a first worm screw mounted on the drive shaft for rotation therewith; and
a second worm screw mounted on the drive shaft for rotation therewith; and
operating the motor to rotate the drive shaft.

19. A single drive positioning system comprising:
a drive shaft;
a motor having a motor output connected to the drive shaft and operable to selectively rotate the drive shaft in each of a clockwise direction and a counterclockwise direction;
a first worm drive including:
a first worm screw mounted on the drive shaft for rotation therewith; and
a first worm wheel intermeshed with the first worm screw;
a second worm drive including:
a second worm screw mounted on the drive shaft for rotation therewith; and
a second worm wheel intermeshed with the second worm screw;
a first overrunning clutch between the drive shaft and the first worm screw, wherein the first overrunning clutch is configured to drive the first worm screw in the clockwise direction when the drive shaft is driven in the clockwise direction, and to permit the drive shaft to rotate independently of the first worm screw when the drive shaft is driven in the counterclockwise direction; and
a second overrunning clutch between the drive shaft and the first worm screw, wherein the second overrunning clutch is configured to drive the second worm screw in the counterclockwise direction when the drive shaft is driven in the counterclockwise direction, and to permit the drive shaft to rotate independently of the second worm screw when the drive shaft is driven in the clockwise direction.

20. A mass analysis system comprising:
an inductively coupled plasma (ICP) torch;
a sample introduction element including an inlet; and
a single drive positioning system operable to selectively align the ICP torch with the inlet, wherein the single drive positioning system includes:
a drive shaft;
a motor having a motor output connected to the drive shaft and operable to selectively rotate the drive shaft;
a first worm screw mounted on the drive shaft for rotation therewith; and
a second worm screw mounted on the drive shaft for rotation therewith.

21.-23. (canceled)
